(19) United States
(12) Patent Application Publication
(10) Pub. No.: US 2015/0183418 A1
(43) Pub. Date: Jul. 2, 2015

(54) APPARATUS AND METHOD FOR CONTROLLING FULL LOAD MODE OF HYBRID ELECTRIC VEHICLE

(71) Applicants: Hyundai Motor Company, Seoul (KR); Kia Motors Corporation, Seoul (KR)

(72) Inventors: Dongjun Shin, Suwon (KR); Chun Hyuk Lee, Suwon (KR)

(21) Appl. No.: 14/468,992

(22) Filed: Aug. 26, 2014

(30) Foreign Application Priority Data
Dec. 26, 2013 (KR) 10-2013-0163785

(51) Int. Cl. B60W 20/00; B60K 6/442

(52) U.S. Cl. CPC B60W 20/102; B60K 6/442; Y10S 903/93

(57) ABSTRACT

An apparatus and a method for controlling a full load mode of a hybrid electric vehicle utilizes an engine and a motor as power sources, and the method includes steps of: calculating a demand torque when the demand torque is generated; determining a current driving mode of the hybrid electric vehicle; calculating a possible assist torque of the motor according to a current driving mode of the hybrid electric vehicle; calculating a part load maximum output torque of the engine; and determining whether to enter the full load mode based on the possible assist torque of the motor and the part load maximum output torque of the engine.

### CROSS-REFERENCE TO RELATED APPLICATION

This application claims under 35 U.S.C. §119(a) priority to and the benefit of Korean Patent Application No. 10-2013-0163785 filed in the Korean Intellectual Property Office on Dec. 26, 2013, the entire contents of which are incorporated herein by reference.

### BACKGROUND

(a) Field of the Invention

The present invention relates to an apparatus and a method for controlling a full load mode of a hybrid electric vehicle. More particularly, the present invention relates to the apparatus and the method for controlling the full load mode of the hybrid electric vehicle that optimizes a possible assist torque of a motor according to a driving mode of the hybrid electric vehicle and reduces a possibility of entering the full load mode, so as to improve fuel efficiency and drivability of the hybrid electric vehicle.

(b) Description of the Related Art

Generally, a driving state of a vehicle may be classified as an idle state, a part load state, and a full load state. The particular load state may be determined by an opening angle of a throttle valve which controls an air-fuel ratio supplied to the engine.

Conventionally, the driving state of the vehicle is determined as the full load state if the opening angle of the throttle valve is greater than a predetermined angle when a driver presses an accelerator pedal, and the full load state means that the vehicle accelerates rapidly or is driven at a high speed.

Thus, an accelerator pedal of a gasoline vehicle is connected to a throttle valve sensor (TPS) and has a linear relationship with the opening angle of the throttle valve, so the driving state of the gasoline vehicle is always determined as the full load state if the accelerator pedal is pressed more than a predetermined level.

Meanwhile, a hybrid electric vehicle is driven by an engine which generates torque from fuel combustion and an electric motor which generates torque from an electric battery. An accelerator pedal of a hybrid electric vehicle is functionally different from the accelerator pedal of a gasoline vehicle.

In particular, the accelerator pedal of the hybrid electric vehicle indicates an intention of the driver, and the intention of the driver is transmitted to controllers as a driving point. Therefore, the accelerator pedal of the hybrid electric vehicle does not have a linear relationship with the opening angle of a throttle valve, and entering the full load mode of the hybrid electric vehicle is controlled as a demand torque of the driver.

In this case, the demand torque of the driver is a sum of an engine torque and a motor torque of the hybrid electric vehicle, so the hybrid electric vehicle enters the full load mode if the demand torque of the driver is greater than a sum of a part load maximum output torque of the engine and a possible assist torque of the motor.

However, in conventional hybrid electric vehicles, the possible assist torque of the motor has a large margin regardless of the driving state of the hybrid electric vehicle. Therefore, driving power through the motor may be insufficient, and the fuel efficiency may be deteriorated because of frequently entering the full load mode.

The above information disclosed in this Background section is only for enhancement of understanding of the background of the invention and therefore it may contain information that does not form the prior art that is already known in this country to a person of ordinary skill in the art.

### SUMMARY

The present invention discloses an apparatus and a method for controlling a full load mode of a hybrid electric vehicle having advantages of optimizing a possible assist torque of a motor according to a driving mode of the hybrid electric vehicle and reducing a possibility of entering the full load mode, so as to improve fuel efficiency and drivability of the hybrid electric vehicle.

An exemplary embodiment of the present invention provides a method for controlling a full load mode of a hybrid electric vehicle having an engine and a motor as power sources that may include: calculating a demand torque when the demand torque is generated; determining a current driving mode of the hybrid electric vehicle; calculating a possible assist torque of the motor according to the current driving mode of the hybrid electric vehicle; calculating a part load maximum output torque of the engine; and determining whether to enter the full load mode based on the possible assist torque of the motor and the part load maximum output torque of the engine.

The possible assist torque of the motor may be calculated by considering a margin according to the engine start when the hybrid electric vehicle drives in an electric vehicle (EV) mode and regardless of the margin according to the engine start when the hybrid electric vehicle drives in a hybrid electric vehicle (HEV) mode.

The possible assist torque of the motor may be calculated based on a battery SOC (state of charge) and a motor speed.

The full load mode may be entered when the demand torque is greater than a sum of the possible assist torque of the motor and the part load maximum output torque of the engine.

The demand torque may be calculated based on a position value of an accelerator pedal, a vehicle speed, and an engine speed.

Another exemplary embodiment of the present invention provides an apparatus for controlling a full load mode of a hybrid electric vehicle having an engine and a motor as power sources that may include a driving information detector configured to detect a current driving state of the hybrid electric vehicle and a controller configured to control an operation of the engine and the motor by receiving an output signal from the driving information detector, and the controller may determine whether to enter the full load mode by calculating a possible assist torque of the motor according to the current driving mode of the hybrid electric vehicle and a part load maximum output torque of the engine when a demand torque is generated.

The driving information detector may include an accelerator pedal position sensor and a vehicle speed sensor.

The controller may calculate the demand torque based on detected values of the accelerator pedal position sensor and the vehicle speed sensor.

The controller may calculate the possible assist torque of the motor by considering a margin according to the engine start when the hybrid electric vehicle drives in an EV mode and regardless of the margin according to the engine start when the hybrid electric vehicle drives in an HEV mode.

The controller may calculate the possible assist torque of the motor based on a battery SOC (state of charge) and a motor speed.

The controller may determine to enter the full load mode when the demand torque is greater than a sum of the possible assist torque of the motor and the part load maximum output torque of the engine.

As described above, according to an exemplary embodiment of the present invention, the possible assist torque of the motor is optimized and the possibility of entering the full load mode is reduced, so fuel efficiency and drivability of the hybrid electric vehicle are improved.

### BRIEF DESCRIPTION OF THE DRAWINGS

FIG. 1 is a schematic diagram of a hybrid system to which a method for controlling a full load mode of a hybrid electric vehicle according to an exemplary embodiment of the present invention is applied.

FIG. 2 is a block diagram of an apparatus for controlling a full load mode of a hybrid electric vehicle according to an exemplary embodiment of the present invention.

FIG. 3 is a flowchart showing a method for controlling a full load mode of a hybrid electric vehicle according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Like reference numerals designate like elements throughout the specification.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

An exemplary embodiment of the present invention will hereinafter be described in detail with reference to the accompanying drawings.

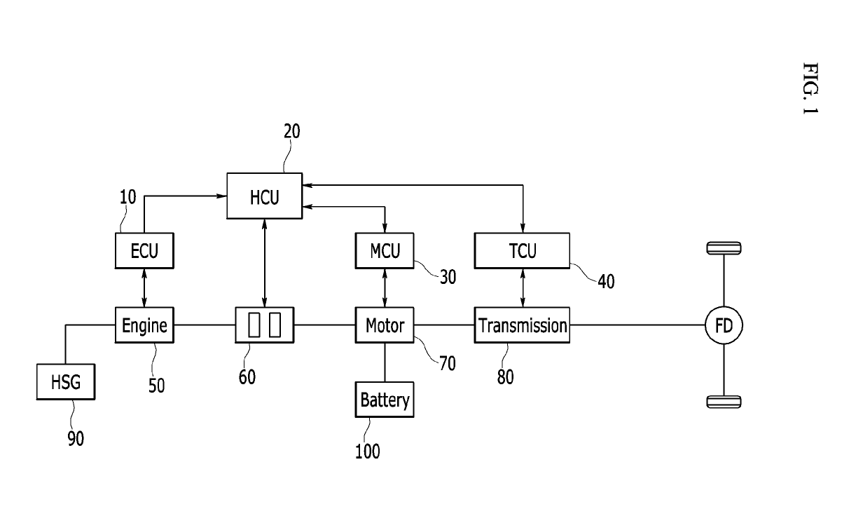

FIG. 1 is a schematic diagram of a hybrid system to which a method for controlling a full load mode of a hybrid electric vehicle according to an exemplary embodiment of the present invention is applied.

The hybrid system as shown in FIG. 1 is an exemplary embodiment of the present invention. Therefore, a method for controlling the full load mode of the hybrid electric vehicle according to the exemplary embodiment of the present invention may not only be applied to the hybrid system as shown in FIG. 1, but may also be applied to other hybrid systems.

Referring to FIG. 1, the hybrid system to which a method for controlling the full load mode of the hybrid electric vehicle is applied according to an exemplary embodiment of the present invention includes an engine control unit (ECU) 10, a hybrid control unit (HCU) 20, a motor control unit (MCU) 30, a transmission control unit

(TCU) 40, an engine 50, an engine clutch 60, a motor 70, a transmission 80, a hybrid starter and generator (HSG) 90, and a battery 100.

The ECU 10 controls an entire operation of the engine 50 according to conditions of the engine 50 such as a demand torque, a coolant temperature, and an engine torque.

The HCU 20 controls operation of other controllers which mutually exchange information in an entire operation of a hybrid electric vehicle, so that the HCU 20 controls output torque of the engine 50 and the motor 70 by cooperating with the other controllers.

The MCU 30 controls an entire operation of the motor 70 according to a demand torque, a driving mode of the hybrid electric vehicle, and an SOC condition of the battery 100.

The TCU 40 controls an entire operation of the transmission 80 such as speed ratios of the transmission 80 depending on output torque of the engine 50 and the motor 70 and an amount of regenerative braking.

The engine 50 outputs power as a power source while turned on. The engine clutch 60 is disposed between the engine 50 and the motor 70 to receive a control signal of the HCU 20 and selectively connect the engine 50 and the motor 70 according to a driving mode of the hybrid electric vehicle.

The motor 70 is operated by the 3-phase AC voltage applied from the battery 160 through an inverter to generate torque, and operates as a power generator and supplies regenerative energy to the battery 100 during coast-down.

The transmission 80 supplies a sum of an output torque of the engine 50 and an output torque of the motor 70 determined by coupling and releasing of the engine clutch 60 as an input torque and selects a shift gear according to a vehicle speed and a driving condition to output driving force to a driving wheel and maintain driving.

The HSG 90 operates as a starter and a generator, starts the engine 50 in response to a control signal from the HCU 20, and generates power by operating as a generator and supplies the generated power as a charge voltage to the battery 100, when the engine 50 keeps operating.

The battery 100 is composed of a plurality of unit cells, and stores a high voltage for supplying a voltage to the motor 70, for example, 400 V or 450 V DC.

The battery 100 supplies a voltage to the motor 70 for supporting power output from the engine 50 in an HEV mode or provides drive force in an EV mode, and is charged by regenerative braking energy.

The hybrid system as described above is obvious to a person of ordinary skill in the art, so a detailed explanation thereof will be omitted.

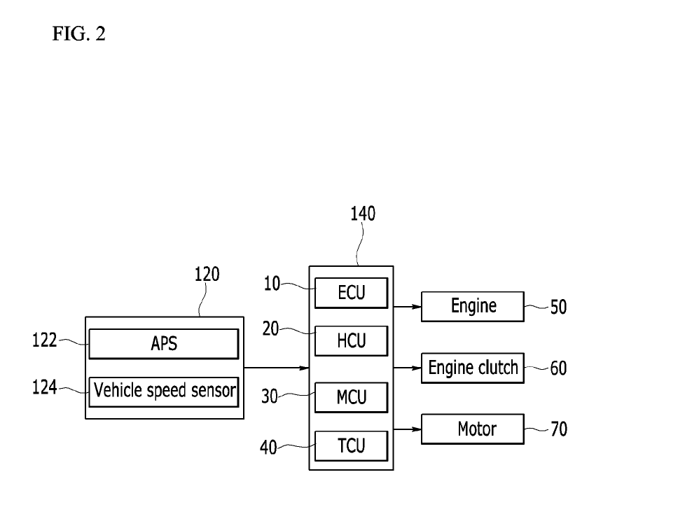

FIG. 2 is a block diagram of an apparatus for controlling a full load mode of a hybrid electric vehicle according to an exemplary embodiment of the present invention.

As shown in FIG. 2, an apparatus for controlling the full load mode of the hybrid electric vehicle according to an exemplary embodiment of the present invention includes a driving information detector 120, a controller 140, the engine 50, the engine clutch 60, and the motor 70.

The controller 140 may perform a method for controlling the full load mode of the hybrid electric vehicle according to an exemplary embodiment of the present invention to be described below through cooperative control between many controllers provided in the hybrid electric vehicle.

Accordingly, for convenience of description, in this specification and the scope of the appended claims, many controllers provided in the hybrid vehicle such as the ECU 10, the HCU 20, the MCU 30, and the TCU 40 are commonly called the controller 140.

The driving information detector 120 includes an accelerator pedal position sensor (APS) 122 and a vehicle speed sensor 124.

The accelerator pedal position sensor 122 continuously detects a position value of an accelerator pedal and transmits a monitoring signal to the controller 140. The position value of the accelerator pedal may be 100% when the accelerator pedal is pressed fully, and the position value of the accelerator pedal may be 0% when the accelerator pedal is not pressed at all.

If the position value of the accelerator pedal is greater than 0%, the controller 140 determines that the driver intends to accelerate. Thus, the controller 140 recognizes a minimum demand torque as 0 Nm, and calculates a demand torque. On the other hand, if the position value of the accelerator pedal is 0%, the controller 140 determines that a minimum demand torque is a creep torque which is a minimum torque according to creep driving of the vehicle.

A throttle valve position sensor (TPS) that is mounted on an intake pipe may be used instead of the accelerator pedal position sensor 122. Therefore, in this specification and the scope of the appended claims, the accelerator pedal position sensor 122 should include the throttle valve position sensor, and the position value of the accelerator pedal should be understood to be an opening value of the throttle valve.

The vehicle speed sensor 124 mounted to a wheel of the hybrid electric vehicle continuously detects a vehicle speed of the hybrid electric vehicle and transmits a monitoring signal thereof to the controller 140.

The controller 140 controls an operation of the engine 50, the engine clutch 60, and the motor 70 by receiving corresponding output signals from the accelerator pedal position sensor 122 and the vehicle speed sensor 124. The controller 140 may confirm an engine speed and a motor speed for controlling operation of the engine 50 and the motor 70.

The controller 140 determines whether to enter the full load mode by calculating a possible assist torque of the motor according to the current driving mode of the hybrid electric vehicle and a part load maximum output torque of the engine when a demand torque is generated.

As provided herein, the controller 140 may determine to enter the full load mode when the demand torque is greater than a sum of the possible assist torque of the motor and the part load maximum output torque of the engine.

The controller 140 may calculate the demand torque based on detected values of the accelerator pedal position sensor 122 and the vehicle speed sensor 124.

The controller 140 may calculate the possible assist torque of the motor based on a battery SOC (state of charge) and a motor speed by considering a margin according to the engine start when the hybrid electric vehicle drives in an EV mode and regardless of the margin according to the engine start when the hybrid electric vehicle drives in an HEV mode.

To this end, the controller 140 may be implemented as at least one processor that is operated by a predetermined program, and the predetermined program may be programmed in order to perform each step of a method for controlling the full load mode of the hybrid electric vehicle according to an exemplary embodiment of the present invention.

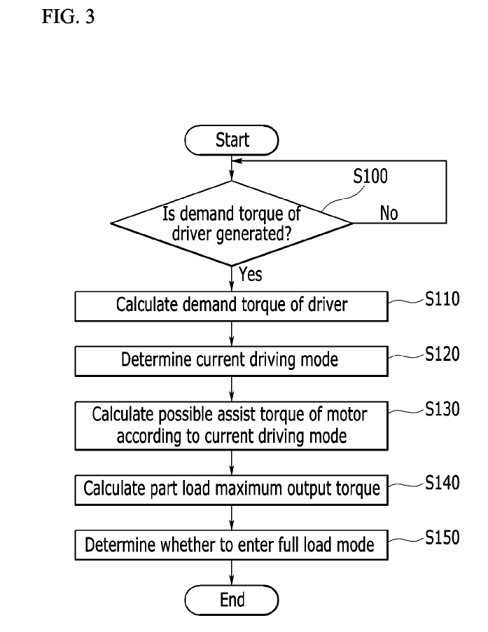

Hereinafter, referring to FIG. 3, a method for controlling the full load mode of the hybrid electric vehicle according to an exemplary embodiment of the present invention will be described in detail.

FIG. 3 is a flowchart showing a method for controlling full load mode of a hybrid electric vehicle according to an exemplary embodiment of the present invention.

Referring to FIG. 3, a method for controlling the full load mode of the hybrid electric vehicle according to an exemplary embodiment of the present invention starts when the controller 140 determines that the demand torque is generated through the APS 122 at step S100.

If the position value of the accelerator pedal is greater than 0%, the controller 140 determines that the driver intends to accelerate.

On the other hand, if the position value of the accelerator pedal is 0%, the controller 140 determines that the driver does not intend to accelerate, and the method for controlling the full load mode of the hybrid electric vehicle according to an exemplary embodiment of the present finishes.

When the demand torque is generated at the step S100, the controller 140 calculates the demand torque at step S110.

The demand torque is calculated according to the position value of the accelerator pedal and the vehicle speed after the controller 140 recognizes a minimum demand torque as 0 Nm.

After the demand torque is calculated at the step S110, the controller 140 determines a current driving mode of the hybrid electric vehicle at step S120.

The hybrid electric vehicle may be driven in a driving mode such as an electric vehicle (EV) mode which is a true electric vehicle mode using only power of the motor 70, a hybrid electric vehicle (HEV) mode which uses rotational force of the engine 50 as main power and uses rotational force of the motor 70 as auxiliary power with the engine, and an RB (regenerative braking) mode for collecting braking and inertial energy during driving by braking or inertia of the vehicle through electricity generation of the motor 70 to charge the battery 100, however, an exemplary embodiment of the present invention may only be applied to the EV mode and the HEV mode. Accordingly, for convenience of description, in this specification and the scope of the appended claims, the driving mode of the hybrid electric vehicle will be classified only as the EV mode and the HEV mode.

When the current driving mode of the hybrid electric vehicle is determined at the step S120, the controller 140 calculates a possible assist torque of the motor 70 according to the current driving mode of the hybrid electric vehicle at step S130.

The possible assist torque of the motor 70 may be calculated based on a battery SOC (state of charge) and a motor speed. The battery SOC may be determined according to a voltage, a current, and a temperature of the battery 100. The motor speed may be determined according to the current amount of charging and discharging of the battery 100.

The possible assist torque of the motor 70 considers a margin according to the engine start when the current driving mode of the hybrid electric vehicle is the EV mode.

On the contrary, the margin according to the engine start is only required to start the engine 50 during the EV mode, so the possible assist torque of the motor 70 does not consider a margin when the current driving mode of the hybrid electric vehicle is the HEV mode.

The possible assist torque of the motor 70 according to the current driving mode of hybrid electric vehicle is calculated at the step S130, and the controller 140 calculates a part load maximum output torque of the engine 50 at step S140.

The part load maximum output torque of the engine 50 may reflect a demand power according to use of the part load. The part load may include not only using mechanical energy such as an operation of an air conditioner and a hydraulic pump, but also using electrical energy converted from a low voltage DC/CD converter (LDC) due to electric load.

The part load maximum output torque of the engine 50 is calculated at the step S140, and the controller 140 determines whether to enter the full load mode at step S150.

The controller 140 determines to enter the full load mode when the demand torque calculated at the step S110 is greater than a sum of the possible assist torque of the motor 70 and the part load maximum output torque of the engine 50.

As described above, according to an exemplary embodiment of the present invention, the possible assist torque of the motor is optimized and the possibility of entering the full load mode is reduced, so fuel efficiency and drivability of the hybrid electric vehicle are improved.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A method for controlling a full load mode of a hybrid electric vehicle having an engine and a motor as power sources, the method comprising:
calculating a demand torque when the demand torque is generated;
determining a current driving mode of the hybrid electric vehicle;
calculating a possible assist torque of the motor according to the current driving mode of the hybrid electric vehicle;
calculating a part load maximum output torque of the engine; and
determining whether to enter the full load mode based on the possible assist torque of the motor and the part load maximum output torque of the engine.

2. The method of claim 1, wherein the possible assist torque of the motor is calculated by considering a margin according to the engine start when the hybrid electric vehicle drives in an electric vehicle (EV) mode and regardless of the margin according to the engine start when the hybrid electric vehicle drives in a hybrid electric vehicle (HEV) mode.

3. The method of claim 2, wherein the possible assist torque of the motor is calculated based on a battery SOC (state of charge) and a motor speed.

4. The method of claim 1, wherein the full load mode is entered when the demand torque is greater than a sum of the possible assist torque of the motor and the part load maximum output torque of the engine.

5. The method of claim 1, wherein the demand torque is calculated based on a position value of an accelerator pedal, a vehicle speed, and an engine speed.

6. An apparatus for controlling a full load mode of a hybrid electric vehicle having an engine and a motor as power sources, the apparatus comprising:
a driving information detector configured to detect a current driving state of the hybrid electric vehicle; and
a controller configured to control an operation of the engine and the motor by receiving an output signal from the driving information detector,
wherein the controller determines whether to enter the full load mode by calculating a possible assist torque of the motor according to the current driving mode of the hybrid electric vehicle and a part load maximum output torque of the engine when a demand torque is generated.

7. The apparatus of claim 6, wherein the driving information detector includes an accelerator pedal position sensor and a vehicle speed sensor.

8. The apparatus of claim 7, wherein the controller calculates the demand torque based on detected values of the accelerator pedal position sensor and the vehicle speed sensor.

9. The apparatus of claim 6, wherein the controller calculates the possible assist torque of the motor by considering a margin according to the engine start when the hybrid electric vehicle drives in an electric vehicle (EV) mode and regardless of the margin according to the engine start when the hybrid electric vehicle drives in a hybrid electric vehicle (HEV) mode.

10. The apparatus of claim 6, wherein the controller calculates the possible assist torque of the motor based on a battery SOC (state of charge) and a motor speed.

11. The apparatus of claim 6, wherein the controller determines to enter the full load mode when the demand torque is greater than a sum of the possible assist torque of the motor and the part load maximum output torque of the engine.
